(19) United States
(12) Patent Application Publication
(10) Pub. No.: US 2024/0125512 A1
(43) Pub. Date: Apr. 18, 2024

(54) CERAMIC HEATER AND LIQUID HEATING DEVICE

(71) Applicant: Niterra Co., Ltd., Nagoya-shi, Aichi (JP)

(72) Inventors: Yusuke MAKINO, Nagoya-shi, Aichi (JP); Yuya HIGASHIDE, Nagoya-shi, Aichi (CN)

(73) Assignee: Niterra Co., Ltd., Nagoya-shi, Aichi (JP)

(21) Appl. No.: 18/277,916

(22) PCT Filed: May 2, 2022
(86) PCT No.: PCT/JP2022/019505

§ 371 Date: Aug. 18, 2023

(30) Foreign Application Priority Data
May 18, 2021 (JP) 2021-083539

(51) Int. Cl. F24H 1/20

(52) U.S. Cl. CPC F24H 1/202; F24H 2250/02

(57) ABSTRACT

A ceramic heater 171,172 comprising: a ceramic base 17g extending in an axial-line-L direction; and a heat generation portion 17a, wherein a length Lh in the axial-line direction of the heat generation portion and a maximum outer diameter D of the ceramic heater satisfy a relationship of 8≤Lh/D.

### TECHNICAL FIELD

The present invention relates to a ceramic heater suitable for heating a liquid such as water, and a liquid heating device using the same.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used.

In particular, for the purpose of rapid heating for warm water of a warm water washing toilet seat, etc., a rod-shaped ceramic heater having a heat generation portion embedded in a ceramic sheet wrapped around the outer circumference of an elongated ceramic base is used (Patent Document 1). In the configuration described in Patent Document 1, the ceramic base has a tubular shape having a through hole, water is introduced into the ceramic heater through the through hole from outside, and heated warm water is discharged from a front end of the ceramic heater.

### PRIOR ART DOCUMENT

### Patent Document

Patent Document 1: WO2006/068131

### SUMMARY OF THE INVENTION

### Problem to be Solved by the Invention

In order to downsize the liquid heating device, the ceramic heater needs to be downsized. However, if the heat generation area becomes small as a result of downsizing of the heater, the heater temperature needs to be more increased so as to generate the same amount of heat as in the conventional case, and thus the heater life might be decreased due to occurrence of crack or the like.

Accordingly, an object of the present invention is to provide a ceramic heater and a liquid heating device in which decrease in the life of a ceramic heater due to downsizing is suppressed.

### Means for Solving the Problem

In order to solve the above problem, a ceramic heater of the present invention is a ceramic heater comprising: a ceramic base extending in an axial-line direction; and a heat generation portion, wherein a length Lh in the axial-line direction of the heat generation portion and a maximum outer diameter D of the ceramic heater satisfy a relationship of 8≤Lh/D.

With this ceramic heater, the ratio of the heat generation portion length to the outer diameter of the ceramic heater becomes great, so that the heat generation portion area becomes large in the axial-line direction. Thus, when a liquid to be heated, such as water, flows along the axial-line direction of the ceramic heater, the contact distance (contact area) with the liquid increases. As a result, heat of the heat generation portion can be effectively transferred to the liquid, whereby excessive increase in the heater temperature can be suppressed.

Thus, the ceramic heater can be downsized, and even if the heat generation temperature becomes high, decrease in the life due to crack, fracture, or the like can be suppressed.

In the ceramic heater of the present invention, the length Lh may be not greater than ⅔ of an entire length LM of the ceramic heater.

With this ceramic heater, criteria for the length Lh and therefore Lh/D are provided.

In the ceramic heater of the present invention, the heat generation portion may be provided only on a front-end side relative to a position away by 5 mm toward the heat generation portion side from an electrode pad connected to the heat generation portion and placed at an outer surface on one end side of the ceramic heater.

With this ceramic heater, criteria for the length Lh and therefore Lh/D are provided.

In the ceramic heater of the present invention, the entire length LM of the ceramic heater may be not greater than 60 mm.

With this ceramic heater, it is ensured that the ceramic heater can be downsized.

In the ceramic heater of the present invention, the maximum outer diameter D may be 1.5 to 5.0 mm.

With this ceramic heater, it is ensured that the ceramic heater can be downsized.

In the ceramic heater of the present invention, an electric resistance value of the heat generation portion may be not less than 12Ω at 180° C.

With this ceramic heater, excessive heater output is suppressed owing to the high electric resistance of the heat generation portion, so that excessive increase in the heater temperature is suppressed, whereby decrease in the life can be further suppressed.

In the ceramic heater of the present invention, the heat generation portion may be formed around an outer circumference of the ceramic base, the ceramic heater further comprising a ceramic sheet wrapped around the outer circumference of the ceramic base and covering the heat generation portion.

With this ceramic heater, production thereof is facilitated.

In the ceramic heater of the present invention, the heat generation portion may be embedded in the ceramic sheet.

With this ceramic heater, production thereof is facilitated.

A liquid heating device of the present invention is a liquid heating device comprising: a container having an internal space, and an inlet and an outlet communicating with the internal space; and one or a plurality of ceramic heaters each stored in the container such that a front-end portion of the ceramic heater faces the internal space, wherein in a process in which a liquid to be heated is introduced from the inlet and flows through the internal space to the outlet, the liquid is heated by the ceramic heater, the ceramic heater is attached to the container by a base-end side of the ceramic heater being retained by the container, the liquid flows from the inlet along an outer surface of the ceramic heater to the outlet, and the ceramic heater is the ceramic heater according to any one of claims 1 to 6.

### Advantageous Effects of the Invention

According to the present invention, a ceramic heater and a liquid heating device in which decrease in the life of a ceramic heater due to downsizing is suppressed, are obtained.

### BRIEF DESCRIPTION OF THE DRAWINGS

FIG. 1 Perspective view showing the outer appearance of a liquid heating device according to an embodiment of the present invention.

FIG. 2 Perspective view showing the outer appearance of a ceramic heater according to the embodiment of the present invention.

FIG. 3 Exploded perspective view showing the configuration of the ceramic heater.

FIG. 4 See-through view along line A-A in FIG. 1.

FIG. 5 Sectional view along line B-B in FIG. 1.

FIG. 6 Sectional view along line C-C in FIG. 5.

FIG. 7 Sectional view along line D-D in FIG. 5.

FIG. 8 Sectional view along line E-E in FIG. 5.

### MODES FOR CARRYING OUT THE INVENTION

Hereinafter, an embodiment of the present invention will be described.

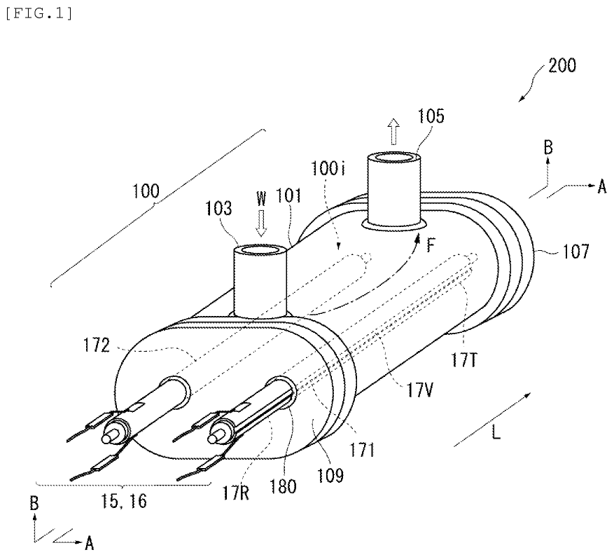

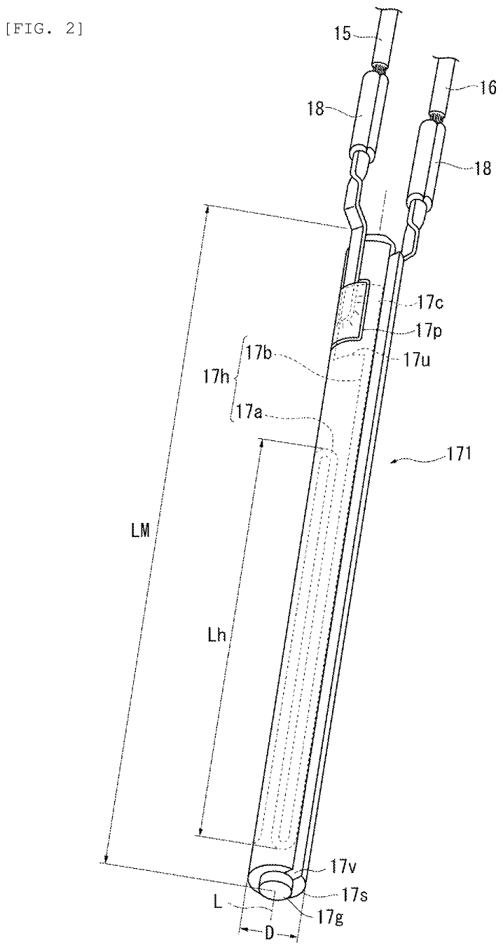

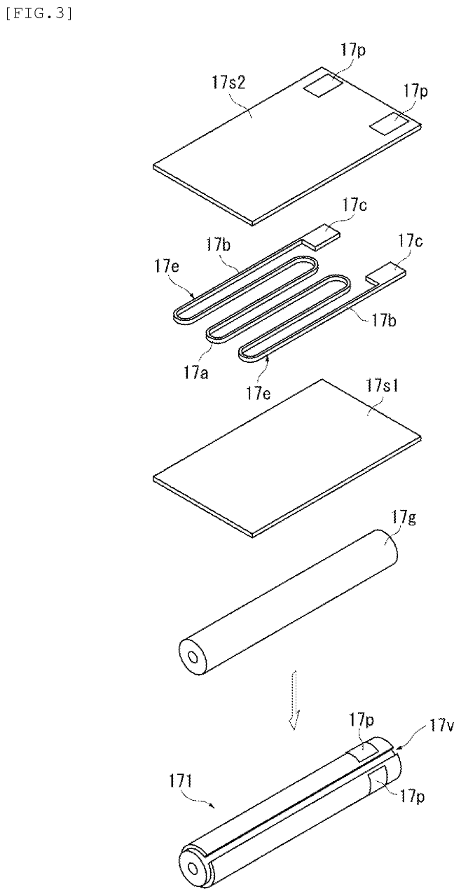

FIG. 1 is a perspective view of a liquid heating device 200 according to the embodiment of the present invention. FIG. 2 is a perspective view showing the outer appearance of a ceramic heater 171. FIG. 3 is an exploded perspective view of the ceramic heater 171.

In this embodiment, the liquid heating device 200 is provided to a warm water washing toilet seat, and heats ordinary-temperature water by two built-in ceramic heaters 171, 172, to supply warm water.

The liquid heating device 200 has substantially an oblong tubular shape (a tubular shape whose cross-section is a rectangle with rounded corners) in its entirety, and has a container 100 and the two ceramic heaters 171, 172.

The container 100 has an oblong tubular trunk portion 101 having an internal space 100i for storing a liquid W (water), a front-end lid 107 and a rear-end lid 109 that close openings at both ends in the axial direction of the trunk portion 101, and an inlet 103 and an outlet 105 for the liquid W which are provided integrally with the trunk portion 101.

Both ends in the axial direction of the trunk portion 101 protrude in a flange shape in the radial direction. Both ends of the trunk portion 101, and the front-end lid 107 and the rear-end lid 109, are respectively sealed with each other in an airtight state by O rings 190 (FIG. 5).

The ceramic heaters 171, 172 have rod shapes extending in an axial-line-L direction, and are arranged side by side toward the same direction (in parallel). A base-end portion 17R of each ceramic heater 171, 172 is retained in a cantilever manner by a sealing portion 180 at an opening of the rear-end lid 109 of the container 100, whereby each ceramic heater 171, 172 is attached to the container 100. A front-end portion 17T of each ceramic heater 171, 172 is located in the internal space 100i. Needless to say, the retained part by the sealing portion 180 is on the base-end side relative to a heat generation portion 17a of the ceramic heater described later.

Here, the state in which the ceramic heaters 171, 172 are arranged side by side toward the same direction (in parallel) means that the greatest value of angles formed by axial lines of all the ceramic heaters 171, 172 is not greater than 10 degrees (including 0 degrees), in consideration of error in installation, and the like.

Lead wires 15, 16 described later for supplying power from outside are connected to the base-end portion 17R sides of the ceramic heaters 171, 172.

In this example, the axial direction of the trunk portion 101 is parallel to the axial-line-L direction, and the ceramic heaters 171, 172 are stored in the internal space 100i of the trunk portion 101 such that the direction in which the ceramic heaters 171, 172 are arranged side by side is along the major axis of the cross-section of the trunk portion 101. However, the axial direction of the trunk portion 101 may have a small predetermined angle with respect to the axial-line-L direction.

Although not shown, in this example, the liquid heating device 200 is provided to the warm water washing toilet seat such that the axial-line-L direction is substantially the horizontal direction and the outlet 105 side is located slightly upward, and the ceramic heaters 171, 172 are laid horizontally.

The inlet 103 and the outlet 105 communicate with the internal space 100i and are located apart from each other in the axial-line-L direction (also corresponding to the axial direction of the trunk portion 101). The liquid W introduced through the inlet 103 from outside passes through the internal space 100i along a flow direction F and then is discharged from the outlet 105.

A gap is formed between the inner wall of the container 100 and each ceramic heater 171, 172. The liquid W introduced into the internal space 100i through the inlet 103 contacts with the outer surfaces of the ceramic heaters 171, 172 along the axial-line-L direction, thus being heated, and then the liquid W flows to the outlet 105.

Next, with reference to FIG. 2 and FIG. 3, the configuration of the ceramic heater according to the embodiment of the present invention will be described. The ceramic heaters 171, 172 have the same shape and therefore the ceramic heater 171 will be described.

As shown in FIG. 2, the ceramic heater 171 has a heat generation body 17h which generates heat by being energized from outside via the lead wires 15, 16. The heat generation body 17h has, on the front-end side, the heat generation portion 17a formed by meandering a conductor in the axial-line-L direction as a heat generation pattern, and has a pair of lead portions 17b led from both ends of the heat generation portion 17a to the rear-end side.

The heat generation portion 17a has a length of Lh in the axial-line-L direction.

More specifically, as shown in FIG. 3, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which lead terminals 18 (see FIG. 2) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The ceramic base 17g may have a tubular shape having a through hole, or a columnar shape with no hole. In a case of a tubular shape, it is desirable to make sealing with resin or the like so as not to leak water from the through hole.

The lead wires 15, 16 are crimped with the lead terminals 18 so as to be electrically connected thereto (see FIG. 2).

Here, in wrapping the laminated body around the ceramic base 17g, the laminated body is wrapped such that both ends along the axial-line-L direction of the laminated body are spaced from each other. Thus, at a wrap-meeting part on the outer surface of the ceramic heater 171, a slit 17v forming a recessed groove along the axial-line-L direction is formed as a non-heat generation portion.

Therefore, as seen in the cross-section of the ceramic heater 171 along the radial direction, the heat generation portion 17a is embedded in the ceramic heater 171 so as to form a ring shape having ends, and the slit 17v as a non-heat generation portion is formed between two ring ends 17e of the heat generation portion 17a.

Alternatively, without the ceramic green sheet 17s1, the heat generation body 17h may be formed by printing or the like on the back-surface side of the ceramic green sheet 17s2, and the ceramic green sheet 17s2 may be wrapped, with the heat generation body 17h side facing the ceramic base 17g. In this case, the heat generation body 17h (heat generation portion 17a) is placed between the ceramic base 17g and the ceramic green sheet 17s2.

On the other hand, in the configuration in FIG. 3, the heat generation body 17h (heat generation portion 17a) is held between the ceramic green sheets 17s1, 17s2, i.e., “embedded” in the ceramic sheet.

As described above, the case where the heat generation portion 17a is embedded in the ceramic sheet (ceramic green sheets 17s1, 17s2) and the case where the heat generation portion 17a is placed between the ceramic base 17g and the ceramic green sheet 17s2, are collectively expressed as “the ceramic sheet has the heat generation portion”.

Next, the detailed configuration of the ceramic heater 171 will be described.

As shown in FIG. 2, the length Lh in the axial-line-L direction of the heat generation portion 17a of the ceramic heater 171 and a maximum outer diameter D satisfy a relationship of 8≤L/D.

In this case, the ratio of the heat generation portion length to the outer diameter of the ceramic heater 171 becomes great, so that the heat generation portion area becomes large in the axial-line-L direction. Thus, when a liquid to be heated, such as water, flows along the axial-line-L direction of the ceramic heater 171, the contact distance (contact area) with the liquid increases. As a result, heat of the heat generation portion 17a can be effectively transferred to the liquid, whereby excessive increase in the heater temperature can be suppressed.

Thus, the ceramic heater can be downsized, and even if the heat generation temperature becomes high, decrease in the life due to crack, fracture, or the like can be suppressed.

If the value of Lh/D is less than 8, the ratio of the heat generation portion length to the outer diameter of the ceramic heater 171 becomes small, so that it becomes difficult to effectively transfer heat of the heat generation portion 17a to the liquid and thus the heater temperature excessively increases. In addition, if D becomes small, the heater becomes likely to be broken.

It is preferable that the value of Lh/D is as high as possible. However, since the length Lh cannot be set to be the entire length LM of the ceramic heater 171 or greater, for example, the upper limit of Lh/D can be prescribed in a range of Lh/LM≤2/3.

In addition, if the length Lh is excessively great, the heat generation portion 17a interferes with the electrode pads 17p on the base-end side of the ceramic heater 171. Therefore, the upper limit of Lh/D may be prescribed such that the heat generation portion 17a is provided only on the front-end side relative to a position 17u away by 5 mm toward the heat generation portion 17a side from the electrode pads 17p.

From the standpoint of downsizing the ceramic heater, it is preferable that the entire length LM is not greater than 60 mm and it is preferable that the maximum outer diameter D is 1.5 to 5.0 mm.

In addition, if the electric resistance value of the heat generation portion 17a is not less than 12Ω at 180° C., excessive heater output is suppressed owing to the high electric resistance of the heat generation portion 17a, so that excessive increase in the heater temperature is suppressed, whereby decrease in the life can be further suppressed.

Further, setting the ceramic heaters 171, 172 to have a watt density not less than 100 W/cm² is preferable because the ceramic heaters and therefore the entire liquid heating device 200 can be downsized.

In addition, as the ceramic heater is more downsized, the heater temperature needs to be more increased, and therefore the present invention becomes more effective.

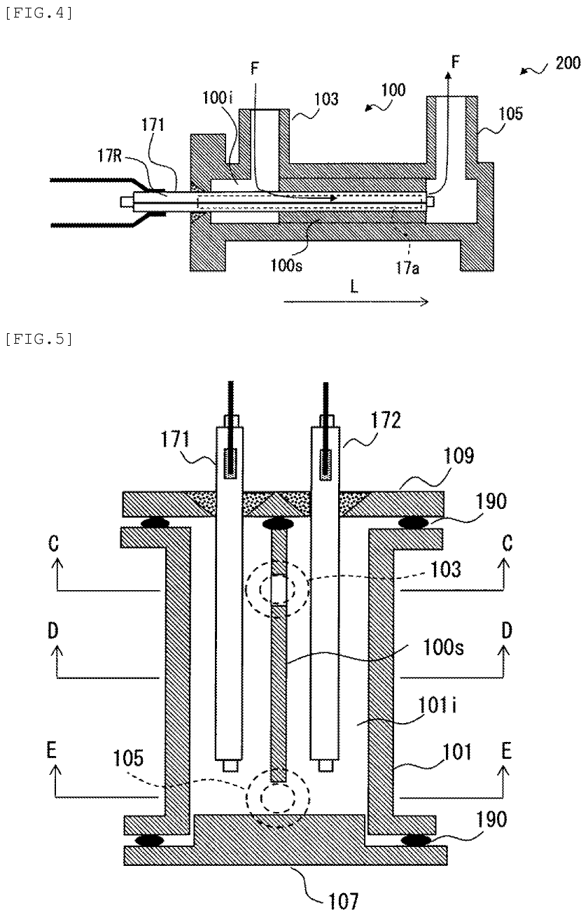

Next, with reference to FIG. 4 to FIG. 6, the detailed configuration of the liquid heating device 200 according to the embodiment of the present invention will be described. FIG. 4 is a view as seen through in a direction perpendicular to the axial-line-L direction and the axial line of the inlet 103.

As shown in FIG. 4, since the inlet 103 and the outlet 105 are located in the axial-line-L direction of the ceramic heaters 171, 172, water introduced from the inlet 103 flows along the flow direction F, while contacting with the outer surfaces of the ceramic heaters 171, 172, to the front-end portion 17T side, toward the outlet 105. Owing to this flow in combination with the ceramic heater 171 satisfying the relationship of 8≤L/D as described above, the contact distance (contact area) when water flows along the axial-line-L direction of the ceramic heater 171 increases, so that excessive increase in the heater temperature can be suppressed.

Next, with reference to FIG. 5 to FIG. 8, the rest of the configuration of the liquid heating device 200 will be described.

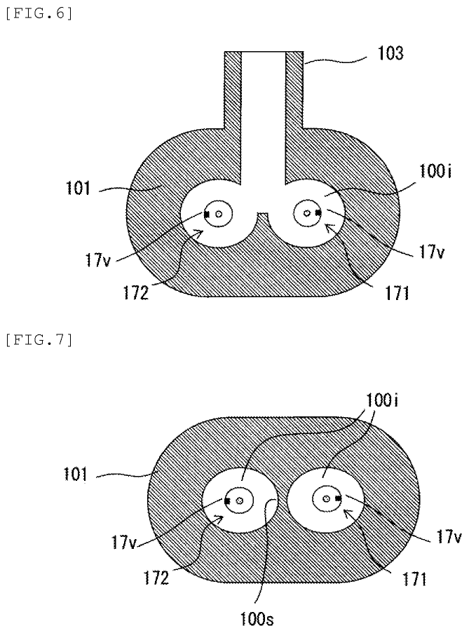

As shown in FIG. 6, the slits 17v of the ceramic heaters 171, 172 face outer sides in the major-axis direction of the container 100 which are sides far from the inlet 103. Thus, the slits 17v do not oppose the liquid that first collides with the outer surfaces of the ceramic heaters 171, 172 from the inlet 103 at a high flow speed, and therefore the liquid first introduced into the internal space 100i is effectively heated by the heat generation portions 17a. As a result, the entire water is uniformly heated, so that heating efficiency is improved.

As shown in FIG. 7, in the internal space 100i between the inlet 103 and the outlet 105, a separation wall 100s is provided for separating the plurality of ceramic heaters 171, 172 one by one from each other, so that the water introduced from the inlet 103 flows for each ceramic heater 171, 172 in the separation wall 100s.

Thus, the water flows through narrow gaps in the separation wall 100s and is heated by each ceramic heater 171, 172, whereby heating efficiency is further improved.

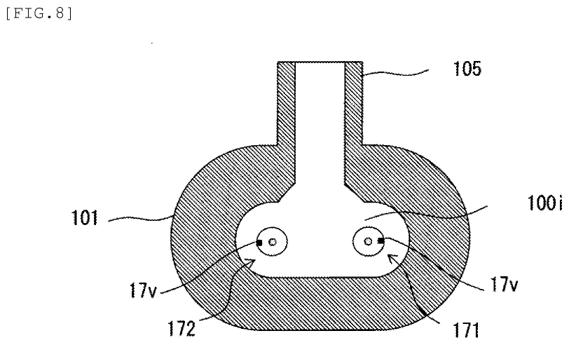

As shown in FIG. 8, in the internal space 100i near the outlet 105, the separation wall 100s is not provided and therefore a single internal space 100i is formed.

Thus, near the outlet 105, the volume of the internal space 100i increases, so that boiling bubbles generated on the inlet 103 side is readily discharged from the outlet 105 to outside. In addition, flows of water heated in each individual separation wall 100s merge together, thus obtaining warm water having uniform temperature.

FIG. 5 is a sectional view taken along the axial-line-L direction so as to pass the center of the minor axis of the liquid heating device 200. FIG. 6, FIG. 7, and FIG. 8 are sectional views perpendicular to the axial-line-L direction in FIG. 5.

It should be understood that the present invention is not limited to the above embodiment and incorporates various modifications and equivalents within the idea and the scope of the present invention.

For example, the shapes of the liquid heating device and the ceramic heater are not limited. The number of ceramic heaters provided to the liquid heating device may be one, or three or more.

The ceramic base 17g of the ceramic heater may be a tubular shape having a through hole, or a columnar shape with no hole. The reason is as follows. Even if the ceramic base 17g has a through hole, as long as the container in which the ceramic heater is provided has such a structure that the inlet and the outlet communicate with the internal space, the liquid flows from the inlet along the outer surface of the ceramic heater to the outlet, and thus the liquid flows in the same manner as in the case of no hole. That is, in the case of the structure in which the liquid is heated by contacting with the outer surface of the ceramic heater, heat transfer efficiency between the heater and the liquid is reduced as compared to the type in which the liquid passes through the inner hole of the ceramic heater. Therefore, the present invention becomes more effective.

### Example

The liquid heating device 200 shown in FIG. 1 was produced.

First, as raw-material ceramic for the ceramic heater, alumina powder and glass-component powder serving as a sintering aid were crushed and mixed with water by a mill, and then were mixed with a binder, to obtain a clay-like mixture. The clay-like mixture was extruded by an extruder using a die with a core placed therein, to form a tubular ceramic base, which was then cut into a predetermined length and calcined. The outer diameter and the length of the ceramic base were adjusted in consideration of a sintering shrinkage factor.

Meanwhile, on an alumina green sheet, a heater pattern and a terminal portion connected thereto and leading to a sheet opposite surface were printed and formed using a tungsten/molybdenum paste. Regarding the size of the heater printed area, dimensions were prescribed while a shrinkage factor in ceramic sintering was taken into consideration. The heater pattern was formed while calculating a resistance value at the room temperature from a resistance value at a high temperature and a resistance change amount (temperature coefficient of resistance×temperature difference×initial resistance value) corresponding to temperature increase. Also for the sheet size, a sintering shrinkage factor was considered, to prepare and cut the sheet.

The printed ceramic green sheet cut in a prescribed size was wrapped around the calcined ceramic base, and these were sintered integrally, thus obtaining ceramic heaters having a heater entire length LM=60 mm and a maximum outer diameter D=2.8 mm in a completed state while changing the length Lh in the axial-line direction of the heat generation portion to various values shown in Table 1. The room-temperature resistance values of the ceramic heaters were 6Ω and 9Ω. The resistance value of each ceramic heater was adjusted by changing the length (number of times of folding) and the thickness of the heat generation portion. An exposed terminal portion of the heater sintered body was plated with Ni, and a lead portion made of Ni was brazed and joined thereto by Ag solder. Then, the lead wire was crimped with the lead portion, thus obtaining the ceramic heater.

Next, two ceramic heaters were attached to a container made of resin. Specifically, the respective ceramic heaters were caused to penetrate two through holes of the rear-end lid, and the ceramic heaters were fixed using an epoxy adhesive as the sealing portions. Then, the rear-end lid, the trunk portion, and the front-end lid were connected in an airtight state via O rings, thus producing the liquid heating device 200.

To the obtained liquid heating device 200, water having a temperature of 5° C. was introduced at a flow rate of 450 cc/min, and application voltage per ceramic heater was controlled so that the flow-out warm-water temperature became 35° C.

The obtained result is shown in Table 1. In Table 1, “/heater” means each property per heater.

TABLE 1

| | | | | Comparative | | Commercial | Commercial |
|---|---|---|---|---|---|---|---|
| | | Examples | | examples | | product 1 | product 2 |
| Electric resistance value of heat | | 6Ω | 9Ω | 6Ω | 9Ω | 6Ω | 9Ω |
| generation portion at 25° C. (Ω/heater) | | | | | | | |
| Dimensions | Lh(mm) | 30.0 | 30.0 | 20.0 | 20.0 | 36.5 | 45.0 |
| of ceramic | D(mm) | 2.8 | 2.8 | 2.8 | 2.8 | 12.1 | 12.1 |
| heater | Lh/D | 10.7 | 10.7 | 7.1 | 7.1 | 3.0 | 3.7 |

| Number of heaters | 2 | 2 | 2 | 2 | 1 | 1 |
|---|---|---|---|---|---|---|
| Heating method | Heater outer surface | | | | Heater inner hole | |
| Application voltage (V/heater) | 85 | 96 | 84 | 98 | 100 | 192 |
| Electric resistance value of heat | 9.5 | 14.3 | 11.0 | 16.0 | 8.2 | 30.7 |
| generation portion at 180° C. (Ω/heater) | | | | | | |
| Heat generation amount (W/heater) | 685 | 640 | 640 | 600 | 1220 | 1200 |
| Watt density (W/cm2) | 442.9 | 413.8 | 622.8 | 583.9 | 59.6 | 50.1 |
| Heater temperature (° C.) | 195 | 188 | 233 | 215 | 146 | 133 |

| | | | |
|---|---|---|---|
| Cycle life(times) | more than 10 | 3 | more than 10 |

As is obvious from Table 1, in Examples in which the relationship of 8≤L/D was satisfied, the heater temperatures were less than 200° C. corresponding to a general thermal shock strength of a ceramic body made of alumina.

In addition, while water continuously flowed at the above flow rate through the liquid heating device 200, voltage was applied for 15 seconds and then the application was stopped for 15 seconds. Even when this cycle was consecutively repeated for 10 cycles, the heaters were not fractured, and thus it has been found that decrease in the life can be suppressed in spite of downsizing of the ceramic heater.

Further, it has been found that, as the electric resistance value of the heat generation portion at 180° C. becomes higher, the heater temperature during voltage application (during heating) becomes lower. From this, it is found that the electric resistance value of the heat generation portion at 180° C. is preferably not less than 12Ω.

Meanwhile, in Comparative examples in which 8>L/D was satisfied, the heater temperature exceeded 200° C. corresponding to the thermal shock strength.

In addition, when the above cycle test was consecutively repeated for three cycles, the ceramic heaters were fractured, and thus the heater life was decreased.

Commercial products 1, 2 are types in which water is heated by passing through a through hole (inner hole) of a ceramic base as in FIG. 1 of Patent Document 1, and a similar container (heat exchanger) as in this FIG. 1 was prepared and each heater was installed.

Also in Commercial products 1, 2, the heater temperatures during heating were less than 200° C. However, the length Lh of the heat generation portion and the maximum outer diameter D of the heater are greater than those in Examples, and therefore it is difficult to downsize the ceramic heaters. In particular, the watt densities are less than 100 W/cm², and thus the heat generation amounts are small in spite of the large sizes of the ceramic heaters.

It is considered that the reason why the dimensions of the commercial products 1, 2 are large is partially because water is heated by passing through the inner hole.

### DESCRIPTION OF REFERENCE NUMERALS

17a heat generation portion
17g ceramic base
17s ceramic sheet
17p electrode pad
100 container
100i internal space
103 inlet
105 outlet
171,172 ceramic heater
200 liquid heating device
L axial-line
W liquid

1. A ceramic heater comprising:
a ceramic base extending in an axial-line direction; and
a heat generation portion, wherein
a length Lh in the axial-line direction of the heat generation portion and a maximum outer diameter D of the ceramic heater satisfy a relationship of 8≤Lh/D.

2. The ceramic heater according to claim 1, wherein
the length Lh is not greater than ⅔ of an entire length LM of the ceramic heater.

3. The ceramic heater according to claim 1, wherein
the heat generation portion is provided only on a front-end side relative to a position away by 5 mm toward the heat generation portion side from an electrode pad connected to the heat generation portion and placed at an outer surface on one end side of the ceramic heater.

4. The ceramic heater according to claim 1, wherein
the entire length LM of the ceramic heater is not greater than 60 mm.

5. The ceramic heater according to claim 1, wherein
the maximum outer diameter D is 1.5 to 5.0 mm.

6. The ceramic heater according to claim 1, wherein
an electric resistance value of the heat generation portion is not less than 12Ω at 180° C.

7. The ceramic heater according to claim 1, wherein
the heat generation portion is formed around an outer circumference of the ceramic base,
the ceramic heater further comprising a ceramic sheet wrapped around the outer circumference of the ceramic base and covering the heat generation portion.

8. The ceramic heater according to claim 7, wherein
the heat generation portion is embedded in the ceramic sheet.

9. A liquid heating device comprising:
a container having an internal space, and an inlet and an outlet communicating with the internal space; and
one or a plurality of ceramic heaters each stored in the container such that a front-end portion of the ceramic heater faces the internal space, wherein
in a process in which a liquid to be heated is introduced from the inlet and flows through the internal space to the outlet, the liquid is heated by the ceramic heater,
the ceramic heater is attached to the container by a base-end side of the ceramic heater being retained by the container,
the liquid flows from the inlet along an outer surface of the ceramic heater to the outlet, and
the ceramic heater is the ceramic heater according to claim 1.
